(19) United States
(12) Patent Application Publication
(10) Pub. No.: US 2010/0174789 A1
(43) Pub. Date: Jul. 8, 2010

(54) RESTFUL FEDERATION OF REAL-TIME COMMUNICATION SERVICES

(75) Inventors: Ronny A. Pena, Bronx, NY (US); John J. Ponzo, Hawthorne, NY (US); Jessica W. Ramirez, Danbury, CT (US); Fenil Shah, Edgewater, NJ (US); Ajamu A. Wesley, Marlborough, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/350,073

(22) Filed: Jan. 7, 2009

(51) Int. Cl. G06F 15/82

(52) U.S. Cl. 709/206

(57) ABSTRACT

A computer-implemented method that includes determining whether a predetermined collaboration client application is available locally at a local client, and using a proxy to integrate the collaboration client application into a web application of a web browser at the local client when the collaboration client application is unavailable locally at the local client, providing real-time presence awareness information of a plurality of users to a first user via the web application at the web browser, receiving, from the first user via the web application, a selection of at least one user of the plurality of users, with whom the first user desires to perform one or more real-time collaboration services, and determining at least one real-time collaboration service that is available via the web browser for use between the first user and the selected user, based at least in part on the real-time presence awareness information of the selected user.

### BACKGROUND

The present invention relates to real-time collaboration, and more specifically, to enabling real-time communication services between users having different messaging environments.

Collaborative software, which is the basis for computer-supported cooperative work, is software designed to help achieve a common task. Real-time collaboration (RTC) software can take a number of different forms such as instant messaging (IM), videoconferencing, application sharing, and netmeetings. For example, IM is a form of real-time communication between two or more users through typed text that is conveyed between computers connected over a network such as the Internet. Some types of IM providers are Sametime Messaging, Google Messaging and Yahoo! Messenger, for example. Application sharing software provides for real-time collaboration through a feature referred to as remote desktop access, which allows graphical applications to be run remotely on a server while being displayed locally. Application sharing enables two or more users to access a shared service or document from their respective computers, simultaneously in real-time.

There are several conventional tools which enable users to collaborate with each other. For example, Meebo, a web-based instant messaging application integrates multiple instant messaging providers, and Sametime Links (STLinks) allows presence awareness information to be added to web pages. There are several problems associated with these conventional tools. One problem is that Meebo fails to provide a mechanism for adding presence awareness or other real-time collaboration services available locally, and STLinks requires a browser plug-in (e.g., a Java Applet) and also may not use real-time collaboration services available locally.

### BRIEF SUMMARY

Embodiments of the present invention provide a system and method allowing web applications to easily incorporate collaboration services (e.g., Sametime services) into any application that supports Hypertext Transfer Protocol (HTTP) and JavaScript, for example. The present invention also allows initiation of real-time collaboration services with a user via a web browser across multiple instant messaging platforms, leverage available local collaboration services, such as video chat, Voice over Internet Protocol (VoIP) and presence awareness from one client (e.g., a Sametime client) within a second client (i.e., the web browser), and obtaining LiveName information (i.e., presence awareness) for users in the context of any web application without requiring any additional browser plug-ins.

According to an embodiment of the present invention, a computer-implemented method of performing collaboration services is provided. The method includes determining whether a predetermined collaboration client application is available locally at a local client, and using a proxy to integrate the predetermined collaboration client application into a web application of a web browser at the local client when it is determined that the predetermined collaboration client application is unavailable locally at the local client, providing real-time presence awareness information of a plurality of users to a first user via the web application at the web browser of the local client, receiving, from the first user via the web application, a selection of at least one user of the plurality of users, with whom the first user desires to perform one or more real-time collaboration services, and determining at least one real-time collaboration service that is available via the web browser for use between the first user and the selected user, based at least in part on the real-time presence awareness information of the selected user.

According to another embodiment of the present invention, a system is provided. The system includes a client system including a web browser including a web application, a server communicating with the client system via a first network and comprising a proxy and a dedicated gateway, and a plurality of third party servers in communication with the server via a second network using the proxy. The system determines whether a predetermined collaboration client application is available at the client system, and uses a proxy to integrate the predetermined collaboration client application into the web application of the web browser when it is determined that the predetermined collaboration client application is unavailable locally at the client system, and provides real-time presence awareness information of a plurality of users to a first user via the web application at the web browser of the client system. The system further receives, from the first user via the web application, a selection of at least one user of the plurality of users, with whom the first user desires to perform one or more real-time collaboration services, and determines at least one real-time collaboration service that is available via the web browser for use between the first user and the selected user, based at least in part on the real-time presence awareness information of the selected user.

According to another embodiment of the present invention, A computer program product comprising a computer useable medium including a computer readable program, wherein the computer readable program when executed on a computer causes the computer to implement a method for performing real-time collaboration services is provided. The method includes determining whether a predetermined collaboration client application is available locally at a local client, and using a proxy to integrate the predetermined collaboration client application into a web application of a web browser at the local client when it is determined that the predetermined collaboration client application is unavailable locally at the local client, providing real-time presence awareness information of a plurality of users to a first user via the web application at the web browser of the local client, receiving, from the first user via the web application, a selection of at least one user of the plurality of users, with whom the first user desires to perform one or more real-time collaboration services, and determining at least one real-time collaboration service that is available via the web browser for use between the first user and the selected user based at least in part on the real-time presence awareness information of the selected user.

Additional features and advantages are realized through the techniques of the present invention. Other exemplary embodiments and aspects of the present invention are described in detail herein and are considered a part of the claimed invention. For a better understanding of the present invention with advantages and features, refer to the description and to the drawings.

### BRIEF DESCRIPTION OF THE SEVERAL VIEWS OF THE DRAWINGS

The subject matter that is regarded as the present invention is particularly pointed out and distinctly claimed in the claims at the conclusion of the specification. The foregoing and other objects, features, and advantages of the various embodiments of the present invention are apparent from the following detailed description of exemplary embodiments taken in conjunction with the accompanying drawings in which:

FIG. 1 is a block diagram illustrating system architecture for performing collaboration services that can be implemented within embodiments of the present invention.

FIG. 2 is a block diagram illustrating an implementation of the system shown in FIG. 1 according to an embodiment of the present invention.

FIG. 3 is flowchart illustrating a computer-implemented method for performing real-time collaboration services that can be implemented within embodiments of the present invention.

FIG. 4 is a block diagram illustrating a general computer system that can be used for implementing exemplary embodiments of the present invention.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the present invention. For instance, the steps may be performed in a differing order, or steps may be added, deleted, or modified. All of these variations are considered a part of the claimed invention.

### DETAILED DESCRIPTION

Embodiments of the present invention can be implemented by employing IBM Lotus Sametime client which is configured to provide an embedded web server that implements the HTTP protocol to enable the hosting of local web applications through HTTP clients (for example, web browsers) in the context of the Sametime application. Sametime is an enterprise real-time collaboration (RTC) software application that provides enterprise instant messaging and chat functionality, presence awareness information, and web conferencing, for example. Sametime provides support for communications standards and standard protocols, including Session Initiation Protocol (SIP), SIMPLE, T.120, XMPP, and H.323.

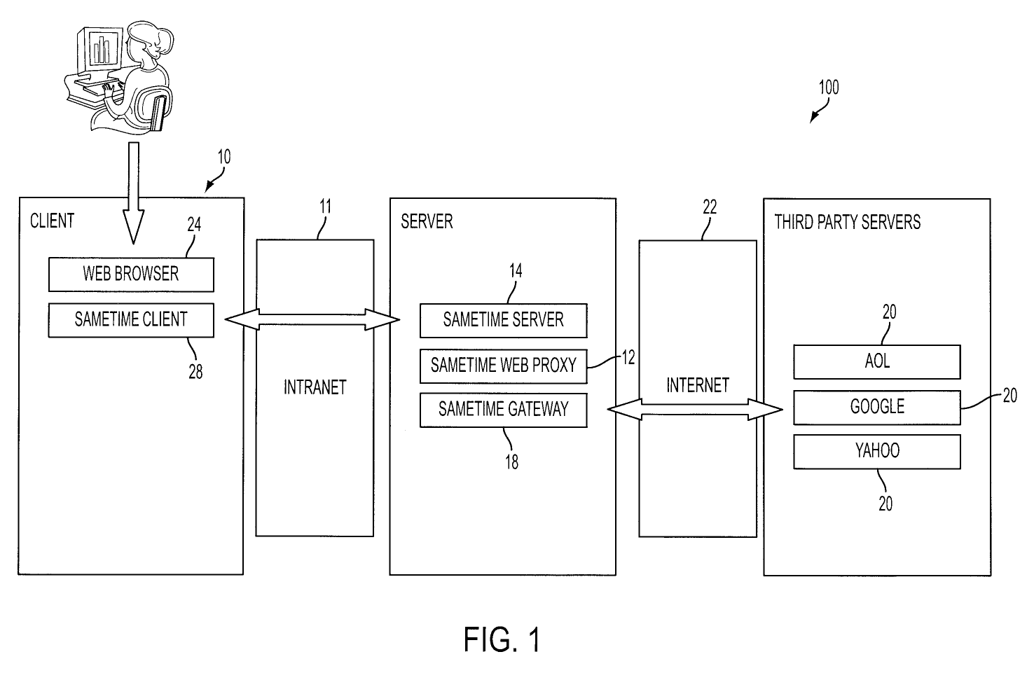

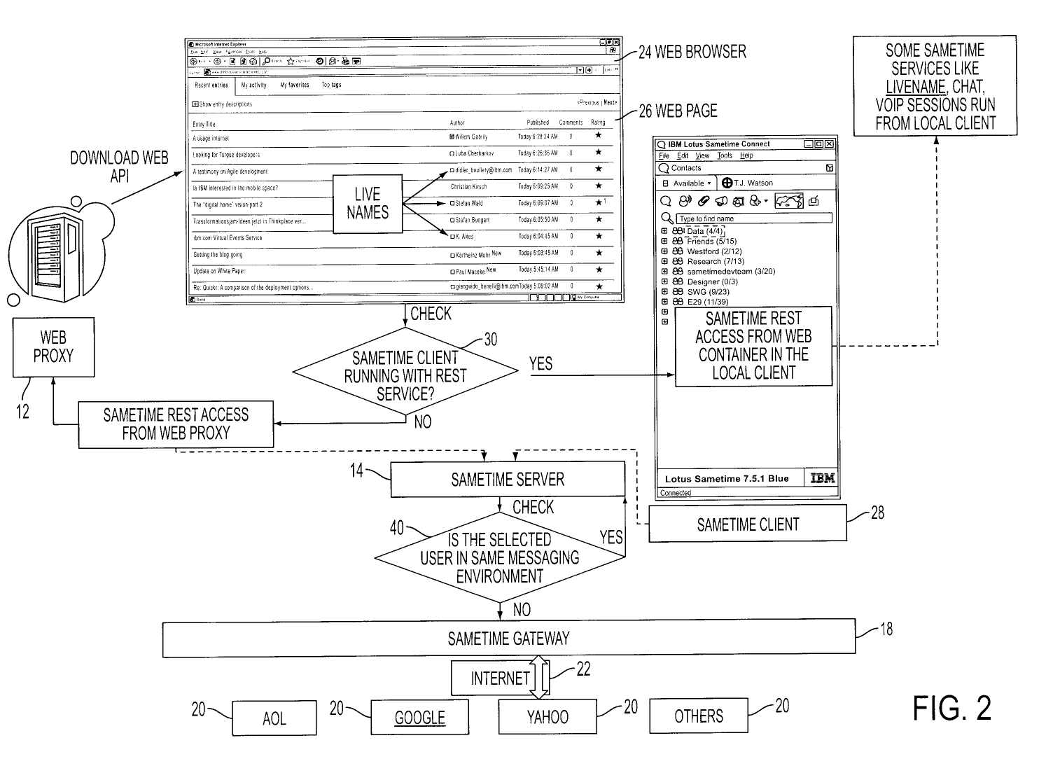

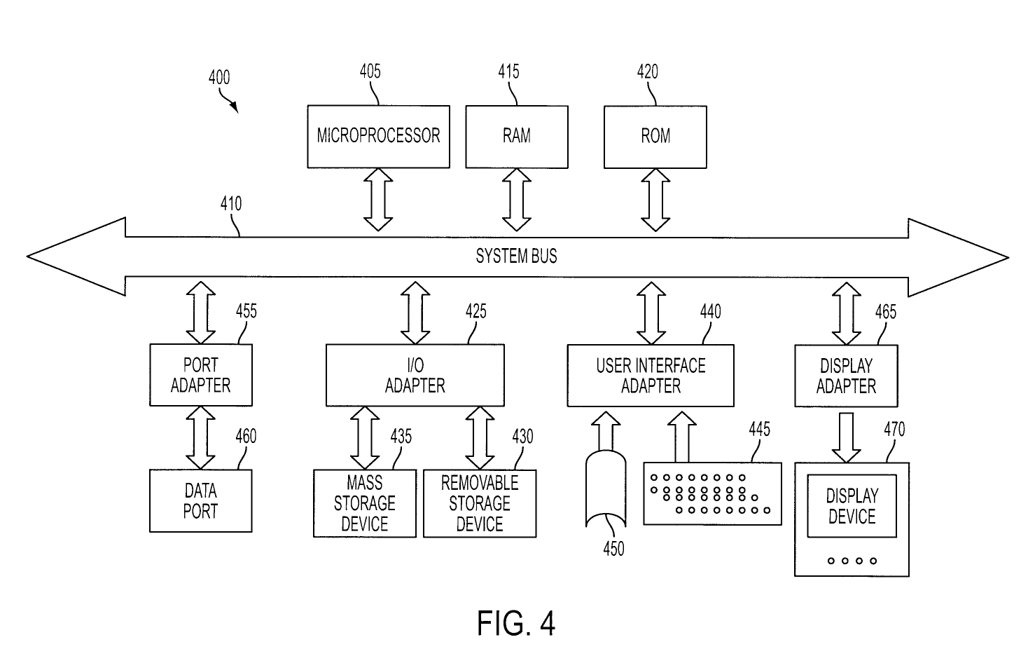

FIG. 1 depicts system architecture 100 according to an embodiment of the present invention. In FIG. 1, the system 100 includes a local client system 10, and a server including a web proxy 12 (e.g., a Sametime web proxy), an originating server 14 (e.g., a Sametime server) and a dedicated gateway 18 (e.g., a Sametime gateway), external to the local client system 10 and in communication with the local client system 10 via a network 11 such as the Intranet. The web proxy 12 may be provided separately from the server. The dedicated gateway 18 is provided for communicating with third party servers (e.g., multiple instant messaging service providers 20, for example, AOL Messaging, Google Messaging, and Yahoo! Messenger via a network 22, such as the Internet. The local client system 10 may be a general computer as shown in FIG. 4 described below. However, the present invention is not limited hereto and may vary accordingly. Further, the local client system 10 includes a web browser 24 and may include a predetermined collaboration client 28 (e.g., a Sametime client). Additional details concerning the local client system 10 will now be described below with reference to FIG. 2.

In FIG. 2, an implementation of the system 100 is shown. As shown in FIG. 2, the web browser 24 of the local client system 10 includes a web application 26 which provides information to a user at the local client system 10. According to an embodiment of the present invention, the information provided via the web application 26 includes a list of a plurality of users and presence awareness information of the plurality of users, for example. The presence awareness information shown in the web application 26 is real-time information which informs the user at the local client system 10 of the availability of a plurality of users such as whether each user is online, away from their computer, or offline. For example, if a user is available (as indicated by the LiveName block and arrows in FIG. 2, pointing to the available users), the user's name may be highlighted or indicated by a specified color. According to an embodiment of the present invention, the web application 26 may be a profile type application or a wiki type application, for example. The present invention is not limited to any particular type of web application 26. In order to provide real-time presence information, a JavaScript application programming interface (API) included on the web application 26 will first detect whether a predetermined collaboration client 28 (e.g., Sametime Connect client) is running locally at the local client system 10 (as shown at the block 30). If so, then an embedded web server in the client 28 will be used to provide information such as presence awareness information and available real-time collaboration services information to the web application 26. If it is detected that the client 28 is not running locally at the local client system 10, predetermined collaboration services (e.g., the Sametime Collaboration services) will be provided from the external originating server 14 (e.g., the Sametime server) via the web proxy 12 using a download web API. These JavaScript components render the appropriate presence awareness information inside the web application 26. If a respective user of the plurality of users is part of another messaging environment, then the originating server 14 (e.g., the Sametime server) connects via the gateway 18 to the remote system, i.e., the respective messaging service provider 20 and obtains real-time presence awareness information.

According to an embodiment of the present invention, the user via the web application 26 at the local client 10 may choose to collaboratively communicate with one of the plurality of users displayed via the web application 26. If so, the user selects a user of the plurality of users and the system 100 determined at least one real-time collaboration service that is available via the web browser 24 for use between the user and the selected user and a list or menu is displayed to the user including all available real-time collaboration services corresponding to the respective user selected. According to an embodiment of the present invention, the available real-time collaboration services may include at least one of presence awareness, online chat, video chat, Voice over Internet Protocol (VoIP), web conferencing or other type of collaboration action. After initial real-time presence awareness information is detected and the available collaboration services are detected based at least in part on the real-time presence awareness information detected, the local client system 10 creates an initial mutex to lock the request with web proxy 12 or the client 28 when available locally. When the web proxy 12 or the client 28 has information to send back to the local client system 10, such as the real-time presence awareness information or available real-time collaboration services, the information is sent along the already open request and when the response is received by the local client system 10, a new open request to the web proxy 12 or the client 28 is created along with a new mutex to lock the request such that other requests cannot be made at the same time and to ensure that the requested information is received by the respective local client system 10.

According to an embodiment, the system 100 determines whether the selected user is a part of the same messaging environment as that of the user (see block 40). That is, the system 100 determines whether the selected user is also a part of the Sametime community, for example, where a distinction is made between a user that is a part of the Sametime community or another messaging service provider 20, based on annotations to a user ID, for example, of the selected user. If the system 100 determines that the selected user is a part of the same messaging environment and the client 28 is installed locally, then the system 100 detects local real-time collaboration services available in the client 28 by way of the server 14. If the system 100 determines that the selected user is a part of the same messaging environment and the client 28 is not installed locally, then the system 100 detects available real-time collaborations services via the web proxy 12 communicating with the server 14. On the other hand, if the selected user is not a part of the same messaging environment and the client 28 is installed locally, then all available real-time collaboration services for the selected user are detected via the client 28 communicating with the gateway 18 via the server 14. If the selected user is not a part of the same messaging environment and the client 28 is not installed locally, then the real-time collaboration services are detected via the web proxy 12 communicating with gateway 18 via the server 14. In this case, the detection of the available real-time collaboration services is performed via the originating third-party server (i.e., the respective messaging service provider 20) using the web proxy 12. The respective messaging service provider 20 broadcasts any available real-time collaboration services associated with the selected user as requested by the user at the local client system 10. If in either case, the request is not answered by the respective messaging service provider 20, then it is determined that there are no real-time collaboration services available for the selected user at the time of the request.

From the list of available real-time collaboration services, the user selects a real-time collaboration service to be performed for collaboratively communicating with the selected user. When the selected user is within the same messaging environment and client 28 is installed locally, the selected real-time collaboration service may be initiated at the web application 26 by accessing the client 28 and when the client 28 is not installed locally, then the selected real-time collaboration service is initiated at the web application 26 by way of the web proxy 12 in communication with the server 14. On the other hand, when the selected user has a different messaging environment other than Sametime and the client 28 is installed locally, the selected real-time collaboration service is initiated at the web application 26 by accessing the client 28 in communication with the gateway 18 by way of the server 14. When the selected user has a different messaging environment and the client 28 is not installed locally, the selected real-time collaboration service is initiated at the web application 26 by way of the web proxy 12 in communication with the gateway 18 via the server 14. Thus, the gateway 18 enables a user at the local client system 10 to collaboratively communicate with other users from different instant messaging platforms.

According to an embodiment of the present invention, JavaScript Object Notation protocol (JSON-P) is used to obtain data from the client 28, which may be different from the domain used by the web application 26. JSON-P is a technique which allows a page originating from one domain to download script from another domain and execute it using JSON as data format.

According to an embodiment of the present invention, the determination as to whether the client 28 is available locally is performed by querying the local client system 10 for a JavaScript variable and if that variable is not defined, the web application 26 determines that the client 28 is not available locally. In addition, according to an embodiment of the present invention, a Java servlet is used to query the client 28 to obtain all available real-time collaboration services. The process after detection of the collaboration services from the web proxy 12 is the same as from the client 28.

According to an embodiment of the present invention, the web proxy 12 and the client 28 contain the same REST APIs. REST is an architecture for building web services on top of the http protocol. Since the web proxy 12 and the web server in client 28 implement the same REST API (Web service API) the real collaboration services added to web application 26 may easily switch between the web proxy 12 and the client 28 depending on availability.

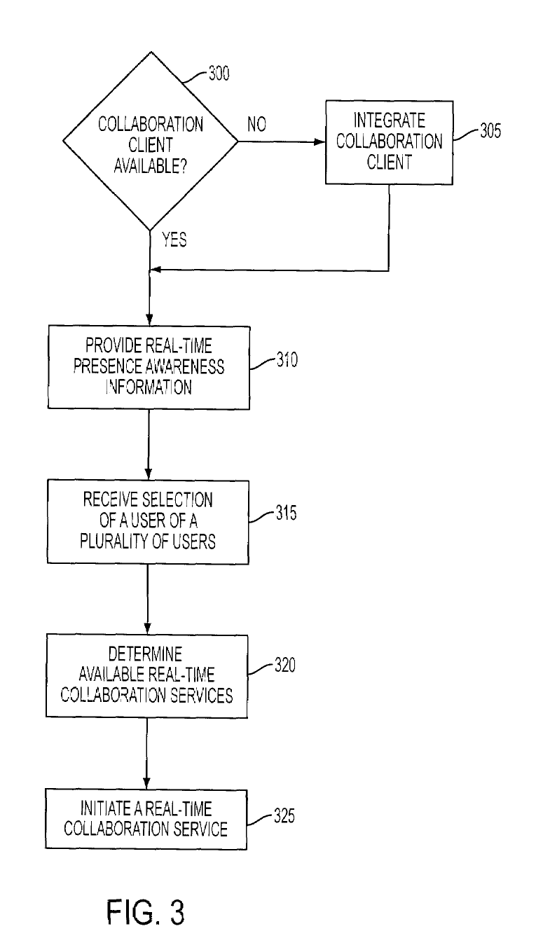

FIG. 3 is a flowchart illustrating a method for performing real-time collaboration services according to an embodiment of the present invention. As shown in FIG. 3, at operation 300, it is determined whether a predetermined collaboration client application (e.g., Sametime connect client 28) is available locally at a local client. If it is determined at operation 300, that the predetermined collaboration client is unavailable locally, then the process moves to operation 305 where using the web proxy, the predetermined collaboration client application is integrated into a web application of a web browser at the local client (as depicted in FIGS. 1 and 2, for example). From operation 300 and 305, the process moves to operation 310 where real-time presence awareness information of a plurality of users is provided to a user via a web application at a web browser of the local client. According to an embodiment of the present invention, the real-time presence awareness information is retrieved via the predetermined collaboration client application available locally at the local client or using the web proxy. The real-time presence awareness information is retrieved via the predetermined collaboration client application when a respective user of the plurality of users is within a same messaging environment as that of the user at the local client and the predetermined collaboration client application is available locally, or via the web proxy when the respective user is within the same messaging environment and the predetermined collaboration client application is integrated via the web proxy. On the other hand, the real-time presence awareness information is retrieved via the predetermined collaboration client application in communication with a gateway communicating with a respective messaging service provider of a plurality of messaging service providers when the respective user is within a different messaging environment from that of the user at the local client and the predetermined collaboration client application is available locally, or via the web proxy communicating with the gateway when the respective user is within a different messaging environment from that of the user and the predetermined collaboration client application is integrated via the web proxy.

From operation 310, the process moves to operation 315 where the user at the local client selects, via the web application, at least one user of the plurality of users, with whom the user desires to perform one or more real-time collaboration services. From operation 315 the process moves to operation 320 where at least one real-time collaboration service that is available is determined via the web browser for use between the user and the selected user based at least in part on the real-time presence awareness information of the selected user. According to an embodiment of the present invention, available real-time collaboration services are retrieved via the predetermined collaboration client application when the selected user is in the same messaging environment and the predetermined collaboration client application is available locally, or via the gateway using the web proxy when the selected user is in the same messaging environment and the predetermined collaboration client application is integrated via the web proxy. On the other hand, the available real-time collaboration services are retrieved via the predetermined collaboration client application in communication with the gateway when the selected user is in a different messaging environment and the predetermined collaboration client application is available locally, or via the gateway using the web proxy when the selected user is in a different messaging environment and the predetermined collaboration client application is integrated via the web proxy.

According to an embodiment of the present invention, the available real-time collaboration services includes at least one of presence awareness, an online chat, video chat, voice over Internet Protocol (VoIP), web conferencing or other type of collaboration action. The available real-time collaboration services are web-based services.

From operation 320, the process moves to operation 325 where the user, at the web browser, initiates a real-time collaboration service as determined with the selected user. According to an embodiment of the present invention, the user initiates the real-time collaboration service at the web browser, via the predetermined collaboration client application when the selected user is within the same messaging environment, and the predetermined collaboration client application is available locally, or via the gateway when the predetermined collaboration client application is integrated via the web proxy. On the other hand, the user initiates the real-time collaboration service via the gateway using the predetermined collaboration client application when the selected user is within a different messaging environment and the predetermined collaboration client application is available locally, or via the gateway using the web proxy when the selected user is within a different messaging environment and the predetermined collaboration client application is integrated via the web proxy.

The system and method according to embodiments of the present invention, enables HTTP communication from a web browser at a local client to different domains without violating the browser security model, detects local real-time collaboration services when available via a locally installed collaboration client and determines available collaboration services across various instant messaging platforms, thereby enabling a user to communicate in real-time with other users having different instant messaging service providers than that of the user.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. This method has the advantage of not requiring a specially designed device or complex software, in order to be implemented.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

Generally, the local client 10 described herein may be a general-purpose computer and the method may be coded as a set of instructions on removable or hard media for use by the general-purpose computer. FIG. 4 is a schematic block diagram of a general-purpose computer suitable for practicing the present invention embodiments. In FIG. 4, computer system 400 has at least one microprocessor or central processing unit (CPU) 405. CPU 405 is interconnected via a system bus 310 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445.

In view of the above, the present method embodiment may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method comprising:
determining whether a predetermined collaboration client application is available locally at a local client, and using a proxy to integrate the predetermined collaboration client application into a web application of a web browser at the local client when it is determined that the predetermined collaboration client application is unavailable locally at the local client;
providing real-time presence awareness information of a plurality of users to a first user via the web application at the web browser of the local client;
receiving, from the first user via the web application, a selection of at least one user of the plurality of users, with whom the first user desires to perform one or more real-time collaboration services; and
determining at least one real-time collaboration service that is available via the web browser for use between the first user and the selected user based at least in part on the real-time presence awareness information of the selected user.

2. The computer-implemented method of claim 1, further comprising:
initiating, via the user at the web browser, a real-time collaboration service as determined with the selected user.

3. The computer-implemented method of claim 2, wherein providing real-time presence awareness information comprises:
retrieving the real-time presence awareness information via the predetermined collaboration client application when a respective user of the plurality of users is within a same messaging environment as that of the first user and the predetermined collaboration client application is available locally, or via the proxy when the respective user is within the same messaging environment and the predetermined collaboration client application is integrated via the proxy; and
retrieving the real-time presence awareness information via the predetermined collaboration client application in communication with a gateway communicating with a respective messaging service provider of a plurality of messaging service providers when the respective user is within a different messaging environment from that of the first user and the predetermined collaboration client application is available locally, or via the proxy communicating with the gateway when the respective user is within a different messaging environment from that of the first user and the predetermined collaboration client application is integrated via the proxy.

4. The computer-implemented method of claim 3, wherein determining at least one real-time collaboration service that is available comprises:
retrieving the at least one real-time collaboration service that is available via the predetermined collaboration client application when the selected user is in the same messaging environment and the predetermined collaboration client application is available locally, or via the gateway using the proxy when the selected user is in the same messaging environment and the predetermined collaboration client application is integrated via the proxy; and
retrieving the at least one real-time collaboration service that is available via the predetermined collaboration client application in communication with the gateway when the selected user is in a different messaging environment and the predetermined collaboration client application is available locally, or via the gateway using the proxy when the selected user is in a different messaging environment and the predetermined collaboration client application is integrated via the proxy.

5. The computer-implemented method of claim 4, wherein initiating, via the user at the web browser, a real-time collaboration service as determined with the selected user comprises:
initiating the real-time collaboration service via the predetermined collaboration client application when the selected user is within the same messaging environment, and the predetermined collaboration client application is available locally, or via the gateway when the predetermined collaboration client application is integrated via the proxy; and
initiating the real-time collaboration service via the gateway using the predetermined collaboration client application when the selected user is within a different messaging environment and the predetermined collaboration client application is available locally, or via the gateway using the proxy when the selected user is within a different messaging environment and the predetermined collaboration client application is integrated via the proxy.

6. The computer-implemented method of claim 4, wherein the at least one real-time collaboration service comprises at least one of presence awareness, an online chat, video chat, voice over Internet Protocol (VoIP), web conferencing or other type of collaboration action.

7. The computer-implemented method of claim 6, wherein the at least one real-time collaboration service is a web-based service.

8. A system comprising:
a client system comprising a web browser including a web application;
a server communicating with the client system via a first network and comprising a proxy and a dedicated gateway; and
a plurality of third party servers corresponding to a plurality of messaging service providers in communication with the server via a second network using the proxy,
wherein the system is configured to:
determine whether a predetermined collaboration client application is available at the client system, and using the proxy to integrate the predetermined collaboration client application into the web application of the web browser when it is determined that the predetermined collaboration client application is unavailable locally at the client system,
provide real-time presence awareness information of a plurality of users to a first user via the web application at the web browser of the client system,
receive, from the first user via the web application, a selection of at least one user of the plurality of users, with whom the first user desires to perform one or more real-time collaboration services, and
determine at least one real-time collaboration services that is available via the web browser for use between the first user and the selected user, based at least in part on the real-time presence awareness information of the selected user.

9. The system of claim 8, wherein the system is further configured to:
initiate, via the user at the web browser, a real-time collaboration service as determined with the selected user.

10. The system of claim 9, wherein the first network is the Intranet and the second network is the Internet.

11. The system of claim 10, wherein the system is further configured to:
retrieve the real-time presence awareness information via the predetermined collaboration client application when a respective user of the plurality of users is within a same messaging environment as that of the first user and the predetermined collaboration client application is available locally, or via the proxy when the respective user is within the same messaging environment and the predetermined collaboration client application is integrated via the proxy; and
retrieve the real-time presence awareness information via the predetermined collaboration client application in communication with a gateway communicating with a respective messaging service provider of a plurality of messaging service providers when the respective user is within a different messaging environment from that of the first user and the predetermined collaboration client application is available locally, or via the proxy communicating with the gateway when the respective user is within a different messaging environment from that of the first user and the predetermined collaboration client application is integrated via the proxy.

12. The system of claim 11, wherein the system is further configured to:
retrieve the at least one real-time collaboration service that is available via the predetermined collaboration client application when the selected user is in the same messaging environment and the predetermined collaboration client application is available locally, or via the gateway using the proxy when the selected user is in the same messaging environment and the predetermined collaboration client application is integrated via the proxy; and
retrieve the at least one real-time collaboration service that is available via the predetermined collaboration client application in communication with the gateway when the selected user is in a different messaging environment and the predetermined collaboration client application is available locally, or via the gateway using the proxy when the selected user is in a different messaging environment and the predetermined collaboration client application is integrated via the proxy.

13. The system of claim 12, wherein the system is further configured to:
initiate the real-time collaboration service via the predetermined collaboration client application when the selected user is within the same messaging environment, and the predetermined collaboration client application is available locally, or via the gateway when the predetermined collaboration client application is integrated via the proxy; and
initiate the real-time collaboration service via the gateway using the predetermined collaboration client application when the selected user is within a different messaging environment and the predetermined collaboration client application is available locally, or via the gateway using the proxy when the selected user is within a different messaging environment and the predetermined collaboration client application is integrated via the proxy.

14. The system of claim 12, wherein the at least one real-time collaboration service comprises at least one of presence awareness, an online chat, video chat, voice over Internet Protocol (VoIP), web conferencing or other type of collaboration action.

15. The system of claim 14, wherein the at least one real-time collaboration service is a web-based service.

16. A computer program product comprising a computer useable medium including a computer readable program, wherein the computer readable program when executed on a computer causes the computer to implement a method for performing real-time collaboration services, the method comprising:
determining whether a predetermined collaboration client application is available locally at a local client, and using a proxy to integrate the predetermined collaboration client application into a web application of a web browser at the local client when it is determined that the predetermined collaboration client application is unavailable locally at the local client;
providing real-time presence awareness information of a plurality of users to a first user via the web application at the web browser of the local client;
receiving, from the first user via the web application, a selection of at least one user of the plurality of users, with whom the first user desires to perform one or more real-time collaboration services; and
determining at least one real-time collaboration service that is available via the web browser for use between the first user and the selected user based at least in part on the real-time presence awareness information of the selected user.

17. The computer program product of claim 16, wherein the method further comprises:
initiating, via the user at the web browser, a real-time collaboration service as determined with the selected user.

18. The computer program product of claim 17, wherein providing real-time presence awareness information comprises:
retrieving the real-time presence awareness information via the predetermined collaboration client application when a respective user of the plurality of users is within a same messaging environment as that of the first user and the predetermined collaboration client application is available locally, or via the proxy when the respective user is within the same messaging environment and the predetermined collaboration client application is integrated via the proxy; and
retrieving the real-time presence awareness information via the predetermined collaboration client application in communication with a gateway communicating with a respective messaging service provider of a plurality of messaging service providers when the respective user is within a different messaging environment from that of the first user and the predetermined collaboration client application is available locally, or via the proxy communicating with the gateway when the respective user is within a different messaging environment from that of the first user and the predetermined collaboration client application is integrated via the proxy.

19. The computer program product of claim 18, wherein determining at least one real-time collaboration service that is available comprises:
retrieving the at least one real-time collaboration service that is available via the predetermined collaboration client application when the selected user is in the same messaging environment and the predetermined collaboration client application is available locally, or via the gateway using the proxy when the selected user is in the same messaging environment and the predetermined collaboration client application is integrated via the proxy; and
retrieving the at least one real-time collaboration service that is available via the predetermined collaboration client application in communication with the gateway when the selected user is in a different messaging environment and the predetermined collaboration client application is available locally, or via the gateway using the proxy when the selected user is in a different messaging environment and the predetermined collaboration client application is integrated via the proxy.

20. The computer program product of claim 19, wherein initiating, via the user at the web browser, a real-time collaboration service as determined with the selected user comprises:
initiating the real-time collaboration service via the predetermined collaboration client application when the selected user is within the same messaging environment, and the predetermined collaboration client application is available locally, or via the gateway when the predetermined collaboration client application is integrated via the proxy; and
initiating the real-time collaboration service via the gateway using the predetermined collaboration client application when the selected user is within a different messaging environment and the predetermined collaboration client application is available locally, or via the gateway using the proxy when the selected user is within a different messaging environment and the predetermined collaboration client application is integrated via the proxy.

21. The computer program product of claim 19, wherein the at least one real-time collaboration service comprises at least one of presence awareness, an online chat, video chat, voice over Internet Protocol (VoIP), web conferencing or other type of collaboration action.

22. The computer program product of claim 21, wherein the at least one real-time collaboration service is a web-based service.
